(19) United States
(12) Patent Application Publication
(10) Pub. No.: US 2015/0284413 A1
(43) Pub. Date: Oct. 8, 2015

(54) METHOD FOR PRODUCING SOLIDS FROM ALKALI METAL SALTS OF SILANOLS

(71) Applicant: Wacker Chemie AG, Munich (DE)

(72) Inventors: Michael Stepp, Ueberackern (AT); Christian Gimber, Ottobrunn (DE); Daniel Schildbach, Altoetting (DE)

(21) Appl. No.: 14/402,239

(22) PCT Filed: May 15, 2013
(86) PCT No.: PCT/EP2013/060016

§ 371 Date: Nov. 19, 2014

(30) Foreign Application Priority Data
May 21, 2012 (DE) 10 2012 208 471.1

(51) Int. Cl. C07F 7/08

(52) U.S. Cl. CPC C07F 7/0836

(57) ABSTRACT

Solid, pulverulent alkali metal siliconates are obtained by removing water from a siliconate solution using an inert liquid.

### CROSS REFERENCE TO RELATED APPLICATIONS

This application is the U.S. National Phase of PCT Appln. No. PCT/EP2013/060016 filed May 15, 2013, which claims priority to German Application No. 10 2012 208 471.1 filed May 21, 2012, the disclosures of which are incorporated in their entirety by reference herein.

### BACKGROUND OF THE INVENTION

1. Field of the Invention

The invention relates to a process for producing solid alkali metal organosiliconates from aqueous solutions thereof in the presence of an inert organic liquid.

2. Description of the Related Art

The alkali metal organosiliconates are also referred to as alkali metal salts of organosilicic acids.

Alkali metal organosiliconates such as potassium methylsiliconate have already been used for decades for hydrophobicization, in particular of mineral building materials. Owing to their good solubility in water, they can be applied as aqueous solution to solids where, after evaporation of the water, they form firmly adhering, lastingly water-repellent surfaces under the action of carbon dioxide. Since they contain virtually no hydrolytically eliminatable organic radicals, curing advantageously occurs without liberating undesired, volatile, organic by-products.

The preparation of alkali metal organosiliconates, in particular potassium and sodium methylsiliconates, has been described many times. In most cases the preparation of ready-to-use and storage-stable, aqueous solutions is the main objective.

For example, DE 4336600 claims a continuous process which starts out from organotrichlorosilanes and goes via the intermediate organotrialkoxysilane. An advantageous aspect here is that the by-products hydrogen chloride and alcohol formed are recovered and the siliconate solution formed is virtually chlorine-free.

Ready-to-use building material mixtures such as cement or gypsum plaster renders and knifing compositions or tile adhesives are mainly delivered to the building site as powder in sacks or silos and only there mixed with the make-up water. This requires a solid hydrophobicizing agent which can be added to the ready-to-use dry mixture and develops its hydrophobicizing action in a short time only on addition of water during use on site, e.g. on the building site. This is referred to as dry mix use. Organosiliconates in solid form have been found to be very efficient hydrophobicizing additives for this purpose. Nevertheless, only few industrially practicable processes for producing them have hitherto been published.

U.S. Pat. No. 2,438,055 describes the preparation of siliconates as hydrates in solid form. In that publication, the hydrolysate of a monoorganotrialkoxysilane or of a monoorganotrichlorosilane is reacted with 1-3 molar equivalents of alkali metal hydroxide in the presence of alcohol. The siliconates obtained as hydrates are crystallized out by evaporation of the alcohol or by addition of appropriate nonpolar solvents.

In Example 1, the preparation of solid sodium methylsiliconate hydrates is described: for this purpose, 1 molar equivalent of methyltriethoxysilane is reacted with 1 molar equivalent of sodium hydroxide in the form of saturated sodium hydroxide solution (i.e. 50% by weight). To crystallize the siliconate, methanol is added to the solution. Obviously, only part of the siliconate precipitates here. Evaporation of the mother liquor gives a further solid which on drying over P₂O₅ at 140° C. displays a weight loss of 21%. Nothing is said about the ratios.

In U.S. Pat. No. 2,803,561, alkyltrichlorosilane is hydrolyzed to the corresponding alkylsilicic acid and the latter is subsequently reacted with alkali metal hydroxide to give an aqueous solution of alkali metal siliconate which is stabilized by addition of alcohol or ketone.

WO2012/022544 describes a practicable process in which the hydrolysis of preferably organoalkoxysilanes is carried out by means of aqueous alkali metal hydroxide solution in the presence of an inert solvent, and the liberated alcohol is subsequently distilled off together with the remaining water. The solid siliconate precipitates in the inert solvent and can, for example, be isolated by filtration or evaporation. A disadvantage is that the recovery of the alcohol is coupled with the isolation of the solid. As soon as some alcohol has been removed, the siliconate precipitates in the mixture. However, hydrolysis and drying/isolation are advantageously carried out in two separate apparatuses which are optimized for the respective process step and do not necessarily have to be positioned directly next to one another. Accordingly, in this case a suspension (solid in an inert solvent) has to be conveyed or transported from the hydrolysis plant to the drying plant, which can, owing to the uncontrollable settling behavior, lead to deposits and technical problems. In addition, a three-component mixture consisting of solvent, alcohol and water has to be separated. The main part of the alcohol and water can be separated off by simple phase separation at an appropriate polarity and density difference from the inert solvent. However, since ethanol and higher alcohols are soluble in the customary, industrially practicable solvents and can thus be separated from the solvent only by means of complicated rectification, the process is restricted to methanol as an elimination product and thus to methoxysilanes as starting materials. In addition, small proportions of solvent in principle dissolve in the alcoholic/aqueous phase, which makes alcohol recycling difficult.

### SUMMARY OF THE INVENTION

The invention provides a process for producing solid alkali metal organosiliconates having a molar ratio of alkali metal to silicon of from 0.1 to 3 from aqueous solutions thereof having a content of alcohols of not more than 5% by weight and a content of halide anions of not more than 1% by weight, wherein the removal of the water from the aqueous solutions is carried out in the presence of an inert liquid F.

### DETAILED DESCRIPTION OF THE PREFERRED EMBODIMENTS

As a result of the removal of the water from the aqueous solutions, the solid alkali metal organosiliconates are obtained as easily isolatable suspension in the inert liquid F. Simple and complete recycling of the dissociation product formed in the hydrolysis step in the preparation of the alkali metal organosiliconates, preferably alcohol or hydrogen halide, is possible in the process.

The aqueous solutions of the alkali metal organosiliconates are in many cases commercially available and can, for example, be produced by known methods by reaction of one or more silanes of the general formula 1

R¹—SiY₃ (1),
with water and a basic alkali metal salt and removal of the dissociation products HY liberated,
   where
R¹ is a monovalent Si—C bonded hydrocarbon radical which has from 1 to 8 carbon atoms and may be unsubstituted or substituted by silyl groups substituted by halogen atoms, amino groups, thiol groups, C₁₋₆-alkyl or C₁₋₆-alkoxy groups and in which one or more nonadjacent —CH₂— units can be replaced by —O—, —S— or —NR³— groups and in which one or more nonadjacent ═CH— units can be replaced by —N═ groups,
Y is hydrogen, F, Cl, Br or OR⁴
R⁴ is a monovalent hydrocarbon radical which has from 1 to 10 carbon atoms and may be unsubstituted or substituted by halogen atoms or silyl groups and in which one or more nonadjacent —CH₂— units can be replaced by —O—, —S— or —NR³—groups and in which one or more nonadjacent ═CH— units can be replaced by —N═ groups,
   wherein the amount of basic alkali metal salt is such that there is at least 0.1 mol, more preferably at least 0.3 mol, and in particular at least 0.5 mol, and not more than 3 mol, more preferably not more than 2 mol, and in particular not more than 1.2 mol, of alkali metal cations per one mole of silicon.

R¹ in the general formula 1 is preferably a monovalent hydrocarbon radical which has from 1 to 18 carbon atoms and may be unsubstituted or substituted by halogen atoms, amino groups, alkoxy groups or silyl groups. Particular preference is given to unsubstituted alkyl radicals, cycloalkyl radicals, alkylaryl radicals, arylalkyl radicals and phenyl radicals. The hydrocarbon radicals R¹ preferably have from 1 to 6 carbon atoms. Particular preference is given to the methyl, ethyl, propyl, 3,3,3-trifluoropropyl, vinyl and phenyl radicals, most preferably the methyl radical.

Further examples of radicals R¹ are:

n-propyl, 2-propyl, 3-chloropropyl, 2-(trimethylsilyl)ethyl, 2-(trimethoxysilyl)ethyl, 2-(triethoxysilyl)ethyl, 2-(dimethoxy-methylsilyl)ethyl, 2-(diethoxymethylsilyl)ethyl, n-butyl, 2-butyl, 2-methylpropyl, t-butyl, n-pentyl, cyclopentyl, n-hexyl, cyclohexyl, n-heptyl, n-octyl, 2-ethylhexyl, n-nonyl, n-decyl, n-undecyl, 10-undecenyl, n-dodecyl, isotridecyl, n-tetradecyl, n-hexadecyl, vinyl, allyl, benzyl, p-chlorophenyl, o-(phenyl)phenyl, m-(phenyl)phenyl, p-(phenyl)phenyl, 1-naphthyl, 2-naphthyl, 2-phenylethyl, 1-phenylethyl, 3-phenylpropyl, 3-(2-aminoethyl)aminopropyl, 3-aminopropyl, N-morpholinomethyl, N-pyrrolidinomethyl, 3-(N-cyclohexyl)aminopropyl, and 1-N-imidazolidinopropyl radicals.

Further examples of R¹ are —(CH₂O)ₙ—R⁸, —(CH₂CH₂O)ₘ—R⁹ and —(CH₂CH₂NH)ₒH radicals, where n, m and o are from 1 to 10, in particular 1, 2 or 3, and R⁸, R⁹ have the meanings of R¹.

R³ is preferably hydrogen or an alkyl radical which has from 1 to 6 carbon atoms and is unsubstituted or substituted by halogen atoms. Examples of R³ are given above for R¹.

R⁴ in the general formula 1 can have ethylenically unsaturated double bonds or can be saturated. Preference is given to monovalent alkyl radicals which have from 1 to 4 carbon atoms, is optionally substituted by alkoxy groups having from 1 to 3 carbon atoms, and which can be linear or branched. Greater preference is given to linear alkyl radicals, and particular preference is given to the methyl and ethyl radicals, in particular the methyl radical.

Further examples of radicals R⁴ are:

n-propyl, 2-propyl, n-butyl, 2-butyl, 2-methylpropyl, t-butyl, 2-(methoxy)ethyl, 2-(ethoxy)ethyl and 1-propen-2-yl radicals.

Examples of compounds of the general formula 1 are: MeSi(OMe)₃, MeSi(OEt)₃, MeSi(OMe)₂(OEt), MeSi(OMe)(OEt)₂, MeSi(OCH₂CH₂OCH₃)₃, H₃C—CH₂—CH₂—Si(OMe)₃, (H₃C)₂CH—Si(OMe)₃, CH₃CH₂CH₂CH₂—Si(OMe)₃, (H₃C)₂CHCH₂—Si(OMe)₃, tBu—Si(OMe)₃, PhSi(OMe)₃, PhSi(OEt)₃, F₃C—CH₂—CH₂—Si(OMe)₃, H₂C═CH—Si(OMe)₃, H₂C═CH—Si(OEt)₃, H₂C═CH—CH₂—Si(OMe)₃, Cl—CH₂CH₂CH₂—Si(OMe)₃, cy-Hex-Si(OEt)₃, cy-Hex-CH₂—CH₂—Si(OMe)₃, H₂C═CH—(CH₂)₉—Si(OMe)₃, CH₃CH₂CH₂CH₂CH(CH₂CH₃)—CH₂—Si(OMe)₃, hexadecyl-Si(OMe)₃. Cl—CH₂—Si(OMe)₃, H₂N—(CH₂)₃—Si(OEt)₃, cyHex-NH—(CH₂)₃—Si(OMe)₃, H₂N—(CH₂)₂—NH—(CH₂)₃—Si(OMe)₃, O(CH₂CH₂)₂N—CH₂—Si(OEt)₃, PhNH—CH₂—Si(OMe)₃, hexadecyl-SiH₃, MeSi(OEt)₂H, PhSi(OEt)₂H, PhSi(OMe)₂H, MeSi(OEt) H₂, propyl-Si(OMe)₂H, MeSiH₃, MeSi(OEt)(OMe)H, (MeO)₃Si—CH₂CH₂—Si(OMe)₃, (EtO)₃Si—CH₂CH₂—Si(OEt)₃, Cl₃Si—CH₂CH₂—SiMeCl₂, Cl₃Si—CH₂CH₂—SiCl₃, Cl₃Si—(CH₂)₆—SiCl₃, (MeO)₃SiSi(OMe)₂Me, MeSi(OEt)₂Si(OEt)₃, MeSiCl₂SiCl₃, Cl₃SiSiCl₃, HSiCl₂SiCl₂H, HSiCl₂SiCl₃, MeSiCl₃, MeSiCl₂H, H₂C═CH—SiCl₃, PhSiCl₃, F₃C—CH₂—CH₂—SiCl₃, Cl—CH₂CH₂CH₂—SiCl₃, MeSi(OMe)Cl₂. MeSi(OEt)ClH, EtSiBr₃, MeSiF₃, Cl—CH₂—SiCl₃, Cl₂CH—SiCl₃. Preference is given to MeSi(OMe)₃, MeSi(OEt)₃, (H₃C)₂CHCH₂—Si(OMe)₃ and PhSi(OMe)₃, with methyltrimethoxysilane or its hydrolysis/condensation product being preferred.

Me is a methyl radical, Et is an ethyl radical, Ph is a phenyl radical, t-Bu is a 2,2-dimethylpropyl radical, cyHex is a cyclohexyl radical, and hexadecyl is an n-hexadecyl radical.

Although there is chemically no upper limit to the amount of water, the proportion of water will for economic reasons be kept very low since excess water has to be removed again. For this reason, a very small amount of water which is just sufficient to allow largely complete hydrolysis and give clear to slightly turbid solutions will be selected. The solids content of the alkali metal organosiliconate solutions is preferably at least 20% by weight, more preferably at least 40% by weight, preferably not more than 70% by weight and more preferably not more than 60% by weight.

In the case of alkoxysilanes as starting material, the alcohol liberated is distilled off to such an extent that the residual concentration of alcohol, in particular of the formula HOR⁴ in the aqueous alkali metal organosiliconate solutions is not more than 5% by weight, more preferably not more than 1% by weight, and in particular not more than 0.1% by weight.

In the case of halosilanes, in particular of the general formula 1, in which Y is F, Cl or Br, as starting materials, these are preferably first reacted with water to form organosilicic acid, with hydrogen halide, in particular HY, being formed. Aqueous solutions of the alkali metal organosiliconates are produced from this organosilicic acid by means of alkali metal hydroxide. In the first step, the amount of water is selected in such a way and the organosilicic acid is optionally washed with water so often that a residual concentration of halide anions, in particular Y, in the aqueous alkali metal organosiliconate solutions of not more than 1% by weight, more preferably not more than 0.1% by weight, and in particular not more than 0.01% by weight, results.

Owing to the virtually complete recycling of the dissociation products, in particular HCl and methanol, the continuous process described in DE 4336600, in which an organoalkoxysilane, in particular of the general formula 1, in which Y=OR⁴, is directly reacted with aqueous alkali metal hydroxide solution with liberation of alcohol, in particular HOR⁴, to form aqueous alkali metal organosiliconate solution, is particularly useful for producing aqueous solutions of alkali metal organosiliconates.

The basic alkali metal salt is preferably selected from among sodium, potassium, cesium and lithium hydroxides. Further examples of basic alkali metal salts are alkali metal carbonates such as sodium carbonate and potassium carbonate and also alkali metal hydrogencarbonates such as sodium hydrogencarbonate, alkali metal formates such as potassium formate, alkali metal silicates (water glass) such as sodium orthosilicate, disodium metasilicate, disodium disilicate, disodium trisilicate or potassium silicate. Furthermore, it is also possible to use alkali metal oxides, alkali metal amides or alkali metal alkoxides, preferably those which liberate the alcohol HOR⁴.

The removal of the water from the aqueous alkali metal organosiliconate solution, also referred to as drying, is preferably carried out by mixing with an inert liquid F and distilling off the water of condensation present and possibly formed and also any residual alcohol and other volatile secondary constituents possibly present. The solid alkali metal organosilicate obtained here can either be used further directly as a suspension in the liquid F or can be isolated by filtration, centrifugation, sedimentation or evaporation of the liquid F. Adhering residues of liquid F are preferably removed either by evaporation or mechanically by blowing-off with a gas stream. The drying conditions are preferably selected so that thermal decomposition of the alkali metal organosilicate can be avoided. Since the boiling point of the liquid F added represents a natural limit, safety risks can be minimized, particularly in the case of alkali metal organosiliconates having a known decomposition temperature, by selection of a liquid F having a correspondingly lower boiling point. However, drying can also be carried out under reduced pressure (relative to ambient pressure). The same applies to the removal of the liquid F.

As inert liquid F, preference is given to using organic solvents which form azeotropes with water, in the case of which drying is carried out under boiling conditions, e.g. using a water separator from which the liquid F is continuously recirculated. However, it is also possible to use high-boiling inert liquids which do not boil under the drying conditions. This makes it possible to exploit at least the advantage of the process that the alkali metal organosiliconate particles do not form lumps as a result of the presence of a suitable inert liquid F and also do not become attached to the stirrer and to the dryer wall, and can thus be isolated more easily.

Suitable inert liquids F are preferably hydrocarbons such as alkanes, cycloalkanes, aromatics or alkylaromatics or mixtures thereof and also ethers and linear or cyclic silicones.

Preference is given to using alkanes and alkane mixtures, cycloalkanes and alkylaromatics, more preferably alkane mixtures. Advantages of alkane mixtures are their advantageous price and their ready availability in various defined boiling ranges.

Preference is given to using solvents which form azeotropes with water. It is also possible to use mixtures of various liquids F.

Examples of liquids F are n-hexane, cyclohexane, n-heptane, cycloheptane, n-octane, cyclooctane, n-nonane, n-decane, n-dodecane, 2-methylheptane, methylcyclopentane, methylcyclohexane, isoparaffins such as Isopar® C, E, G, H, L, M from ExxonMobil, benzene, toluene, o-xylene, m-xylene, p-xylene, mesitylene, ethylbenzene, methyl tert-butyl ether, diethyl ether, diphenyl ether, phenyl methyl ether and di-n-butyl ether, tetrahydrofuran, 1,4-dioxane, ethylene glycol dimethyl ether, diethylene glycol dimethyl ether, dichloromethane, trichloromethane, tetrachloromethane, diisopropylamine, triethylamine, pyridine, and acetonitrile. As high boilers (bp. at least 150° C.), it is possible to use, for example, commercially available isoparaffins (e.g. Hydroseal® G400H from Total).

The proportion of the liquid F in the total mixture is selected so that good stirrability of the suspension formed is ensured. It is preferably at least 50% by weight, more preferably at least 100% by weight, and preferably not more than 500% by weight, in particular not more than 300% by weight, of the expected amount of solid.

Particular preference is given to using azeotrope formers having a boiling point of not more than 10° C. below the decomposition temperature of the alkali metal organosiliconate, which can be determined by means of DSC, as inert liquid F. Particular preference is given to using inert liquids in which water has a solubility of not more than 2% by weight at 20° C.

The azeotropic removal of the water is preferably carried out under ambient pressure. Drying with the aid of a high-boiling (min. 150° C.) inert liquid F below its boiling point is preferably carried out by heating to a temperature at which the water vaporizes, more preferably under reduced pressure.

The removal of the liquid F present on the solid alkali metal organosiliconate is particularly preferably carried out under reduced pressure and by heating to a temperature at which the inert liquid F vaporizes.

The solid alkali metal organosiliconate isolated preferably has a solids content determined gravimetrically at 160° C. of at least 96% by weight, more preferably at least 98% by weight, and in particular at least 99% by weight.

The aqueous alkali metal organosiliconate solution is preferably placed together with the liquid F in a vessel, the mixture is heated to reflux and the water is distilled off together with the liquid F. If the liquid F is an azeotrope former, the boiling point of the mixture increases or decreases with increasing degree of drying until the boiling point of the pure liquid F has been reached. This indicates that the drying operation is largely complete and the liquid F can be distilled off, preferably under reduced pressure, until the alkali metal organosiliconate is present as solid residue, or a mechanical isolation of solid can be carried out.

In order to achieve a very high space-time yield, the inert liquid F is preferably introduced during drying in such a way the degree of fill of the drying vessel remains constant, i.e. only the volume of water distilled off is replaced by the liquid F. If the liquid F is not miscible with water at the respective condensate temperature, this can easily be automated, for example using a liquid separator which is filled with the inert liquid F before collection of the aqueous distillate. Here, precisely the amount of inert liquid corresponding to the amount of water distilled off flows back into the reaction vessel. In this procedure, the progress of drying can be monitored in a simple way by determining the amount of water in the separator, e.g. by measurement of the volume or weight, and the end point determined. Heating is most preferably continued to the boiling point of the inert liquid F.

If water dissolves in the inert liquid F, distillation is preferably carried out without a liquid separator, to the boiling point of the liquid F, optionally under reduced pressure. If desired, fractional distillation is carried out via a distillation column having an appropriate separation power in order to separate water and liquid F from one another by distillation. Here, mixtures of water and liquid F, possibly together with residues of alcohol from the hydrolysis reaction which can be purified separately, are usually obtained as distillates. In this process variant, fresh liquid F is preferably in each case introduced during the distillation in such an amount that the reaction mixture remains stirrable.

In a further preferred process variant which is particularly suitable for a continuous mode of operation, a solution of the alkali metal organosiliconate is brought into contact with the liquid F under conditions under which the volatile constituents of the solution vaporize and the alkali metal organosiliconate salt precipitates as solid. The aqueous alkali metal organosiliconate solution is preferably mixed with the liquid F. When the volatile constituents are distilled out, the solid alkali metal organosiliconate is obtained as a suspension in the liquid F and can be isolated by filtration, centrifugation, sedimentation or evaporation of the inert liquid F. The inert liquid F is preferably placed in a vessel and the solution of the alkali metal organosiliconate is introduced under conditions which ensure immediate vaporization of the volatile constituents. The optimal conditions in the particular case can be easily determined by a person skilled in the art by variation of the amount of liquid F, temperature, pressure and/or introduction rate. If the solution of the alkali metal organosiliconate is introduced in finely divided form, e.g. via a nozzle, into contact with the inert liquid F, the vaporization operation can be accelerated. Here, the siliconate solution is preferably introduced directly into the liquid F under the surface of the latter. The alkali metal organosiliconate particles formed immediately on introduction can be discharged continuously as a suspension from the reaction vessel and passed to an optionally continuous isolation of solids. The liquid F can be recovered virtually completely and be reused in the process. In this way, apparatus sizes and amounts of liquid F employed (hold up) can be kept small despite high throughput rates. A further positive effect of this process variant is the short residence time of the siliconate solution under distillation conditions (preferably above room temperature), so that even thermally unstable siliconate solutions can be brought completely and without decomposition phenomena into suspensions which generally have a higher thermal stability. A further advantage is that the particle size distribution of the alkali metal organosiliconate particles formed can be influenced via the temperature of the liquid F during introduction of the alkali metal organosiliconate solution. In general, lower temperatures lead to a greater average particle size.

It is an advantage of the process of the invention that solid to paste-like adhering materials on the mixing apparatuses and the reactor wall become detached with increasing degree of drying in this process and a finely divided suspension from which the solid alkali metal organosiliconate can be isolated by simple solids separation such as filtration, sedimentation or centrifugation is formed. In a preferred variant, the volatile constituents of the finely divided suspension are distilled off at ambient pressure or under reduced pressure and the solid alkali metal organosiliconate obtained is dried. This preferably occurs at temperatures below the decomposition temperature to be determined individually, (e.g. by means of a DSC measurement) of the suspension or of the dried solid, i.e. usually at temperatures below 160° C., preferably below 140° C., particularly preferably below 120° C. Overheating and uncontrollable decomposition reactions triggered thereby are avoided by means of this gentle drying. The liquid F separated off in the isolation of the solid can be used for flushing the plant in order to flush out last residues of solid and to increase the yield. The solid which has been isolated by, in particular, filtration, sedimentation or centrifugation can be dried further by passing optionally heated inert gas through/over it, or in a drying oven or heated mixer, optionally under reduced pressure and preferably to constant weight.

The process can be carried out batchwise, e.g. using a stirred vessel or paddle dryer with distillation attachment, as is customary in multipurpose plants. Owing to the low formation of deposits, it is usually not necessary to clean the dryer in order to remove solid residues between the individual batches of campaigns. Should cleaning nevertheless be necessary, e.g. at the end of the campaign, this can easily be carried out inexpensively and without harmful emissions by simple flushing or optionally flooding of the plant with water due to the good solubility in water. A continuous process in a thin-film evaporator or a mixing/conveying apparatus such as a kneader or a single-screw or twin-screw extruder, an essentially horizontal paddle dryer, preferably with a plurality of chambers for the various process steps, is likewise possible and advantageous for industrial production. In this case, a proportion of previously dried alkali metal organosiliconate or of another solid can be initially placed in the drying apparatus in order to accelerate the drying operation and the alkali metal organosiliconate which is still moist with water or contaminated with liquid F can be introduced.

All symbols in the above formulae respectively have their meanings independently of one another. In all formulae, the silicon atom is tetravalent.

In the following examples and comparative examples, all amounts and percentages are, unless indicated otherwise, by weight and all reactions are carried out at a pressure of 0.10 MPa (abs.).

### Production Example 1

### Drying of an Aqueous Solution of Potassium Methylsiliconate (Silres® BS16 Wacker Chemie AG) Using Isopar E (Filtration)

200 g of a 54% strength aqueous solution of potassium methylsiliconate (Silres® BS16, commercially available from Wacker Chemie AG) and 173 g of Isopar E (isoparaffinic hydrocarbon mixture having a boiling range of 113-143° C., commercially available from ExxonMobil) are placed in a 1000 ml 5-neck round-bottom flask which is provided with blade stirrer, dropping funnel, thermometer and water separator with reflux condenser and has been made inert by means of nitrogen. The water separator is filled to the brim with Isopar E. While stirring, the mixture is heated to the boiling point. 109.1 g of water are collected up to a boiling point of 118° C. During the distillation, a paste-like white solid precipitates in the reaction mixture and this quickly disintegrates into fine particles and forms a suspension. The suspension is filtered through a Beco KD3 filter plate on a pressure filter and nitrogen is passed through the solid until the weight is constant. This gives 85.4 g of a fine, white, free-flowing powder whose solids content is 99.5% (determined using the solids content balance HR73 Halogen Moisture Analyzer from Mettler Toledo at 160° C.). The elemental analysis of the solid gives 22.6% of Si, 9.5% of C, 3.3% of H, 32.7% of O, 31.9% of K, which corresponds to a molar ratio of K:Si of 1.01. The following average structural formula can be derived therefrom: [(KO)(OH)SiMe]₂-O.

The thermal stability of the solid is examined by means of dynamic scanning calorimetry (DSC). Above 222° C., the substance displays a decomposition enthalpy of 634 J/g. The aqueous solution of SILRES® BS 16 employed displays a decomposition enthalpy of 659 J/g from 157° C.

### Production Example 2

### Drying of an Aqueous Solution of Potassium Methylsiliconate (Silres® BS16 Wacker Chemie AG) Using Toluene (Concentration by Evaporation)

In a 500 ml 5-neck round-bottom flask which is provided with blade stirrer, dropping funnel, thermometer and water separator with reflux condenser and has been made inert by means of nitrogen, 58.6 g of a 54% strength aqueous solution of potassium methylsiliconate (Silres® BS16, commercially available from Wacker Chemie AG) are admixed with 73.8 g of toluene and heated to reflux. During the course of drying, the boiling point rises from 95° C. to 110° C. and 27.1 g of water separate out in the toluene-filled water separator, corresponding to the expected amount. The heterogeneous mixture remains stirrable during the entire drying phase. A white foam formed transiently increasingly breaks up to form a finely divided suspension which is evaporated at an oil bath temperature of 150° C. and at 10 hPa. This gives 31.9 g of a fine, white, flour-like powder whose solids content is 99.4% (determined using the solids content balance HR73 Halogen Moisture Analyzer from Mettler Toledo at 160° C.)

### Production Example 3

### Drying of an Aqueous Solution of Potassium Methylsiliconate (Silres® BS16 Wacker Chemie AG) by Dropwise Introduction into Isopar E

124.5 g of Isopar E (isoparaffinic hydrocarbon mixture having a boiling range of 113-143° C., commercially available from ExxonMobil) are placed in a 1000 ml 5-neck round-bottom flask which is provided with blade stirrer, dropping funnel, thermometer and water separator with reflux condenser and has been made inert by means of nitrogen and are heated to reflux. The water separator is filled to the brim with Isopar E. While stirring at 350 rpm, 100 g of a 54% strength aqueous solution of potassium methylsiliconate (Silres® BS16, commercially available from Wacker Chemie AG) are introduced in such a way that the temperature of the mixture does not drop below 110° C. (duration: 50 minutes). The mixture is then refluxed for a further hour until no more water droplets separate out. A total of 45.7 g of water separate out as lower phase in the water separator, corresponding to the expected amount. During after-drying, a paste-like white solid precipitates in the reaction mixture and this increasingly breaks up into fine particles and forms a suspension. This is evaporated at an oil bath temperature of 100° C. and 10 hPa and the solid residue is dried at 10 mbar for a further hour. This gives 52.8 g of a fine, white, free-flowing powder whose solids content is 99.6% (determined using the solids content balance HR73 Halogen Moisture Analyzer from Mettler Toledo at 160° C.)

### Comparative Example 1 which is not According to the Invention

### Experiment on Drying of an Aqueous Solution of Potassium Methylsiliconate (Silres® BS16 Wacker Chemie AG) by Driving Off the Water by Heating

A commercially available, 54% strength aqueous solution of potassium methylsiliconate (Silres® BS16, Wacker Chemie AG) is heated in a three-neck flask. The solution is concentrated by passing about 40 l/h of nitrogen over the liquid surface at a distance of 2 cm above it. As the concentration increases, the product foams very strongly and white solid separates out and gradually builds up inward from the periphery of the flask. At 122° C., the temperature rises to 277° C. within 10 minutes. The water evaporates completely. White, firmly adhering encrustations are formed at the periphery of the flask. The ²⁹Si-NMR spectrum of the solid shows the virtually quantitative loss of the methyl groups.

In Use Example 1, commercial gypsum plasters in powder form (Goldband ready-to-use gypsum plaster Light and machine gypsum plaster MP 75 from Knauf Gips KG, Iphofen/Germany) were mixed effectively with varying amounts of potassium methylsiliconate powder in dry form from Production Example 1. This dry mixture was subsequently added a little at a time to the make-up water while stirring as per the formulation indicated on the packaging and stirred by means of an electrically operated blade stirrer at a moderate speed of rotation to give a homogeneous slurry (Goldband ready-to-use plaster Light: 300 g of gypsum plaster powder and 200 g of water, machine plaster MP 75: 300 g of gypsum plaster powder and 180 g of water, in each case as indicated on the packaging). The slurry obtained was subsequently poured into PVC rings (diameter: 80 mm, height: 20 mm) and the gypsum plaster was cured for 24 hours at 23° C. and 50% relative atmospheric humidity. After removal of the gypsum plaster test specimens from the rings, the test specimen was dried to constant weight at 40° C. in a convection drying oven. To determine the water absorption by a method based on DIN EN 520, the test specimens were weighed to determine the dry weight and stored under water for 120 minutes after determining the dry weight; here, the specimens were laid horizontally on metal meshes and the depth of water above the highest point of the test specimens was 5 mm. After 120 minutes, the test specimens were taken from the water, allowed to drip on a water-saturated sponge and the percentage water absorption was calculated from the wet weight and the dry weight according to the formula

Percentage water absorption={[mass(wet)−mass(dry)]/mass(dry)}·100%

The results are shown in Table 1. They show a very strong hydrophobicizing effectiveness of the potassium methylsiliconate powder.

TABLE 1

| Plaster | Goldband ready-to-use plaster Light | | | | Machine plaster MP 75 | | | |
|---|---|---|---|---|---|---|---|---|
| Amount introduced | 0% | 0.2% | 0.4% | 0.6% | 0% | 0.2% | 0.4% | 0.6% |
| Water absorption | 36% | 18.2% | 1.6% | 1.2% | 40% | 12.4% | 2.3% | 2.2% |

1.-7. (canceled)

8. A process for producing solid alkali metal organosiliconates having a molar ratio of alkali metal to silicon of from 0.1 to 3 from aqueous solutions thereof having a content of alcohols of not more than 5% by weight and a content of halide anions of not more than 1% by weight, comprising removing of the water from the aqueous solutions in the presence of an inert liquid F.

9. The process of claim 8, wherein the aqueous solutions of the alkali metal organosiliconates are produced by reacting one or more silanes of the formula 1
R¹—SiY₃ (1),
with water and a basic alkali metal salt and removing the dissociation products HY liberated, where
R¹ is a monovalent Si—C bonded hydrocarbon radical which has from 1 to 8 carbon atoms, optionally substituted by silyl groups substituted by halogen atoms, amino groups, thiol groups, C₁₋₆-alkyl or C₁₋₆-alkoxy groups and in which one or more nonadjacent —CH₂— units are optionally replaced by —O—, —S— or —NR³— groups and in which one or more nonadjacent ═CH— units are optionally replaced by —N═ groups,
Y is hydrogen, F, Cl, Br or OR⁴
R⁴ is a monovalent hydrocarbon radical which has from 1 to 10 carbon atoms, optionally substituted by halogen atoms or silyl groups and in which one or more nonadjacent-CH₂-units are optionally replaced by —O—, —S— or —NR³— groups and in which one or more nonadjacent ═CH— units are optionally replaced by —N═ groups,
wherein the amount of basic alkali metal salt is such that there is from 0.1 to 3 mol of alkali metal cations per one mole of silicon.

10. The process of claim 9, wherein R¹ is a hydrocarbon radical having from 1 to 6 carbon atoms.

11. The process of claim 9, wherein R⁴ independently are methyl or ethyl radicals.

12. The process of claim 10, wherein R⁴ independently are methyl or ethyl radicals.

13. The process of claim 8, wherein the solids content of the alkali metal organosiliconate solutions is at least 20% by weight.

14. The process of claim 9, wherein the solids content of the alkali metal organosiliconate solutions is at least 20% by weight.

15. The process of claim 10, wherein the solids content of the alkali metal organosiliconate solutions is at least 20% by weight.

16. The process of claim 11, wherein the solids content of the alkali metal organosiliconate solutions is at least 20% by weight.

17. The process of claim 8, wherein the inert liquid F is a hydrocarbon, ether, silicone, or mixture thereof.

18. The process of claim 9, wherein the inert liquid F is a hydrocarbon, ether, silicone, or mixture thereof.

19. The process of claim 8, wherein, after removal of water, solid alkali metal organosiliconates are obtained as a suspension in the inert liquid F, and are isolated by filtration, sedimentation, centrifugation or distilling-off of the volatile constituents of the suspension.
